(19) United States
(12) Patent Application Publication
(10) Pub. No.: US 2005/0242234 A1
(43) Pub. Date: Nov. 3, 2005

(54) Lifters, methods of flight control and maneuver load alleviation

(75) Inventor: Vedad Mahmulyin, Seattle, WA (US)

Correspondence Address: SHIMOKAJI & ASSOCIATES, P.C., 8911 RESEARCH DRIVE, IRVINE, CA, 92618, US

(73) Assignee: The Boeing Company, Chicago, IL (US)

(21) Appl. No.: 10/837,464

(22) Filed: Apr. 29, 2004

(51) Int. Cl. B64C 3/58

(52) U.S. Cl. 244/75.1; 244/213

(57) ABSTRACT

The present invention provides a flight control system and method for various models of aircraft, including thin-winged, long range, transonic and low supersonic aircraft, and may be beneficial on supersonic and hypersonic aircraft as well. One embodiment of the flight control system comprises a plurality of lifters for generating lift or drag, the plurality of lifters mechanically associated with a lower surface of each wing in a pair of wings. During operation, the lifters may be selectively deployed alone or in combination with other flight control devices, such as ailerons and spoilers, to provide various operative benefits such as improved roll control, speed braking functionality, and maneuver load alleviation.

### BACKGROUND OF THE INVENTION

The present invention generally relates to aircraft flight control devices; and, more particularly, to a deployable lower surface control device for transonic and low supersonic speed roll control and for speed braking.

Flight control devices have been used since the inception of mechanical flight. For example, ailerons have long been used to generate or destroy lift. Ailerons, for example, may be located on the outboard part of an airfoil or wing, aligned with the trailing edge of the wing. Ailerons are typically hinged to the wing, and deflect at upward and downward angles relative to the wing. Deployed downward on the left wing, the ailerons generate lift and oppose the force of gravity, deployed upward on the right wing ailerons destroy lift, enabling roll control, or stirring the aircraft directionally to the right. Lift has also been augmented with the use of lower surface flow control devices, used in earlier times on vintage models such as World War II heavy, subsonic type bomber aircraft, and used as flaps or high lift devices for takeoff and landings. Thereafter, studies conducted pertaining to the use of lifters taught away from lifter implementation, concluding ineffective roll control at high angles of attack, which is a problem that designers of fighter aircraft were trying to solve. Ailerons are also selectively deployed on a single wing to create wing lift, enabling roll maneuvers necessary for turns. For example, the U.S. Pat. No. 6,554,229 to Lam, et al. discloses an aircraft aileron system comprised of two panels located at the outboard portion of the wing.

Use of ailerons, however, invite a number of adverse flight conditions and reduce some aspects of flight performance. One issue includes the inherit limitation of aileron functionality. When attempting to create lift on one wing, excessive downward deployment of the associated aileron may result in a loss of lift on the associated wing. Further, deployed ailerons and their associated actuator and hinges create drag. The thinner the wing, as required for high-speed transonic and low supersonic flight, the greater the actuator and hinge jut from the wing, and the greater the drag force. Increased drag forces degrade performance and require additional flight components to offset untoward effects. For example, the drag generated by extension of the aileron on one wing may result in adverse yaw moments, where the aircraft nose is forced in a direction opposite to its intended turn, such that the aircraft's longitudinal axis forms an angle with its intended direction of flight. This yawing action is often countered and the turn enabled, to some degree, by one or more flight control means, including deployment of the opposite-wing ailerons upward from the airfoil and rudder application to trim out the yaw. While the ailerons may be typically used symmetrically on both sides so these yaw forces from aileron drag cancel each other out, some inboard ailerons can induce a large angle of attack (sidewash) on the vertical tail caused by the flow's rotation around fuselage and resulting in huge loads on the structure of the entire aft body and very unfavorable yawing moment. These undesirable effects may or may not be countered with the rudder, depending how powerful the rudder is. Some aircraft, for example, do not have enough rudder power to counter these conditions. These types of aircraft may include, for example, commercially viable airplanes having relatively close proximity of the vertical tail and the ailerons on the wing.

Various ailerons and rudder control functionality, however, requires large, complex system configurations, which typically results in greater overall weight, thus further degrading aircraft performance and capabilities, particularly in specific types of aircraft which rely on streamlined, lightweight designs to achieve high speeds or high efficiency and high maneuverability, such as fighter aircraft.

Some of the aforementioned issues were addressed with upper wing surface control devices such as spoilers. Used alone or in conjunction with ailerons, spoilers annihilate lift on one or both wings. Spoilers, for example, typically comprise a flat panel unfoldably fitted to an upper surface of the wings, immediately inboard of the outboard ailerons. The spoilers are generally hinged along a rear spar to permit deflection upward at an angle relative to the wing. As a reminder, wings produce lift if a lower surface pressure is greater then the upper surface pressure. Deflection of spoilers creates air pressure buildup forward of it, so an increase in pressure on the upper skin and no change on the lower skin by definition results in reduction of lift as well as creation of drag, and, if used symmetrically, spoilers have a little profile drag but mainly they destroy a lot of lift. To make up for the lost lift, the airplane has to go to a higher angle of attack, which creates significant drag, thus acting as speed brakes or emergency descent devices. Alternatively, spoilers may be deployed asymmetrically as a roll control device. Spoilers cause large pressure buildup in front of them and so they destroy lift in that section of the wing. Net lift on that (left or right) wing is smaller than the opposite side wing, causing that wing to start sinking, which creates roll and turns the airplane. It will also yaw the airplane (not necessarily adversely) because of the drag, but that is a secondary effect easily trimmed out by the rudder. For example, the U.S. Pat. No. 6,491,261 to Blake discloses a wing mounted yaw control device hingedly mounted on a first wing surface and a deflector hingedly mounted on a second wing surface for use with an all-wing, tailless aircraft. The use of spoilers, however, is limited by the available upper surface area, the relative thickness of the wing, and positional and operational considerations affecting flight control on different wing models. Use of lifters on the right wing in conjunction with spoilers on the left wing may balance out yawing moment and pitching moment. For example, use of the spoilers is known to create change in pitching moments (movement up and down of an aircraft's nose and tail, respective to its longitudinal axis or line of flight) during flight.

Another flight control issue centers around loading on the wing. When the airplane is pulling g's, or accelerating upward at, for example, 2.5×g (9.81 m/sec²), the wings have to sustain the load of approximately 2.5 times the weight of the airplane, resulting in an undesirable bending moment.

Despite the use of various flight control devices, certain aircraft such as high-speed, high-efficiency, long-range aircraft are particularly susceptible to flight control issues. All models rely on structural designs such as long, thin wings, single or twin vertical tail configurations to achieve various flight objectives. Further, aircraft having relatively thin, long wings tend to suffer aeroelastic loss (bending moment) during roll maneuvers, including those deploying outboard ailerons (positioned relatively near to the wingtip) or middle ailerons (positioned mid-wing relative to the wingtip and the body of the aircraft). A thin, hollow wing or wing structure is by nature less stiff than a thick wing design, therefore prone to high tip bending or flexibility. A flexible aft swept wing is by definition aeroelastic, so prone to aeroelastic effectiveness loss of any outboard device (aileron or spoiler). This aeroelastic phenomenon may make any economically viable commercial airplane design very sluggish in roll maneuvers, and possibly uncertifiable by regulatory agencies such as the FAA. This may also make military platforms too sluggish and, therefore, unacceptable for performance requirements for certain aircraft having, for example, thin-wing, long-span, high efficiency semi-delta wings.) Deployment of outboard ailerons for roll purposes can actually reverse roll effectiveness, thus cannot be used during roll maneuvers. Middle ailerons lose their effectiveness when deployed at relatively high speeds—Mach 0.9, for example—and at relatively high dynamic pressures. Inboard ailerons (positioned closer to the body of the aircraft than to the wingtip) provide only about one-third of the required roll control for commercial transports and even less of a fraction for many military mission airplanes, and are thus insufficient as a viable flight control solution. Theoretically, both middle ailerons and inboard ailerons could be deployed to achieve more roll; however, in practice hinge moments (load on hinge devices) become intolerable and still result in deficient roll control. Further, the upflow of air on one side of the aircraft and downflow on the other caused by use of the left wing inboard ailerons and right wing inboard ailerons, respectively, produce a circular or spiral flow around the fuselage from wing to tail, inducing an angle of attack (or sidewash) on the vertical tail that produces significant yawing moments. Such yawing moment is untrimmable by a reasonably configured rudder; i.e., a rudder that appropriately conforms to size and weight requirements for a particular model of aircraft. The adverse effect of such use of the inboard ailerons is particularly severe on aft wing—canard configurations (aircraft having a horizontal stabilizer in front of the wings, such as some models having twin vertical tail configurations), due to the relative proximity of the vertical tail and the trailing edge devices. Further, concurrent use of the middle and inboard ailerons produces huge loads which the structure must sustain, thus necessitating heavier components, increasing costs, and decreasing performance.

Upper surface control devices have been used on thin-winged aircraft to address some of the aforementioned issues. Spoilers, for example, have been used to improve roll control. Spoilers, however, are also subject to aeroelastic loss, albeit to a lesser degree than ailerons. Thus, spoilers recover some roll power, but not enough to meet commercial transport requirements; for example, 60 degrees/4 seconds with one hydraulic system unoperational. In certain aircraft embodiments, spoilers located in front of inboard ailerons decrease the effectiveness of inboard ailerons, thus negating the benefit derived from inboard placement of the ailerons. Spoilers located in front of the middle ailerons considerably improve the flight operations. Because the middle ailerons have little effectiveness, some designs curtail actual use of the aileron, thus saving on construction costs for the actuator or other components used as deployment mechanisms.

Another possible configuration, with inboard ailerons and spoilers located in front of the middle ailerons, still fails to produce an acceptable level of roll control. Yet another configuration consisting of spoilers located in front of the outboard ailerons fail to produce the desired drag due to the aeroelasticity of the wing at that location. Further, many configurations do not provide enough configurable space at the outer wing to accommodate spoilers.

As can be seen, there is a need for flight control devices and methods having the functionality to provide discrete and broad improvements in flight performance, control, and maneuverability without attendant adverse effects. It is further desirable to provide such a device and method with broad application to a variety of aircraft and to do so with economic feasibility.

### SUMMARY OF THE INVENTION

An aspect of the present invention includes at least one lifter deployably attached to a lower wing surface for use with an aircraft.

Another aspect of the present invention includes aircraft wings, each with an upper surface; a lower surface; an inboard region; a middle region; and an outboard region; as well as a plurality of lifters, whereby each lifter in the plurality of lifters may be deployably attached to the lower surface of the wing for use with an aircraft.

Yet another aspect of the present invention for use with an aircraft includes a pair of wings, where each wing in the pair of wings has a lower surface, an upper surface, a inboard region, a middle region, and an outboard region; a plurality of lifters, where each lifter in the plurality of lifters may be attached to either the inboard region or the middle region of the lower surface of each wing in the pair of wings; a plurality of a hinge mechanisms for pivotally attaching each lifter in the plurality of lifters to a respective wing in the pair of wings; and a plurality of actuators, each actuator in the plurality of actuators in operative engagement with a respective hinge mechanism in the plurality of hinge mechanisms, each actuator in the plurality of actuators for selectively actuating the hinge mechanism, causing an angular deployment or return of a respective lifter in the plurality of lifters from or to its initial position relative to the lower surface of one wing in the pair of wings. Still another aspect of the present invention includes means for selectively downwardly deploying ailerons and lifters on one wing of an aircraft having a vertical tail to generate lift; and means for selectively upwardly deploying the spoilers and the lifters on the other wing.

A further aspect of the present invention includes means for selectively deploying the ailerons and lifters on one wing of an aircraft to generate lift; and means for selectively upwardly deploying the spoilers and the lifters on the other wing.

A still further aspect of the present invention includes a plurality of lifters, where each lifter in the plurality of lifters may be attached to a lower surface of a long, thin aircraft wing.

Yet a further aspect of the present invention includes steps for selectively deploying, on an aircraft, at least a portion of a plurality of lifters and at least portion of a plurality of spoilers during flight to cause drag on the aircraft, reducing its speed.

A yet still further aspect of the present invention includes steps for selectively deploying ailerons and lifters on one wing of an aircraft to generate lift; and selectively upwardly deploying the spoilers and the lifters on the other wing of the aircraft.

Another aspect of the present invention includes a step for selectively deploying at least a portion of the plurality of lifters.

These and other features, aspects and advantages of the present invention will become better understood with reference to the following drawings, description and claims.

### BRIEF DESCRIPTION OF THE DRAWINGS

FIG. 1 is a plan view of lifters mounted on an aircraft, according to an embodiment of the present invention;

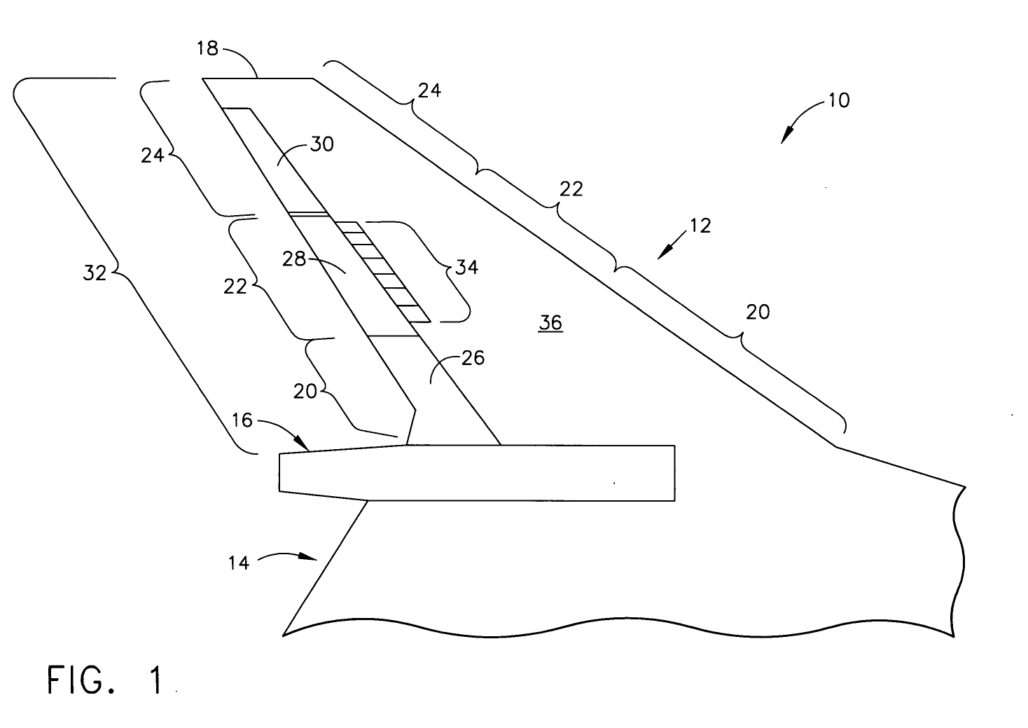

FIGS. 2 and 3 are diagrammatic, rear views of an aircraft having flight control devices, according to an embodiment of the present invention;

FIG. 4 is a diagrammatic, front view of an aircraft having lifters configured in an inboard region of the wings, according to an embodiment of the present invention;

FIG. 5 is a diagrammatic, plan view of an aircraft, according to an embodiment of the present invention;

FIG. 6 is a space view of a trailing edge of an airfoil, according to an embodiment of the present invention;

FIG. 7 is a cross-sectional view of a portion of an airfoil having flight control devices with attachment means, according to an embodiment of the present invention; and

FIG. 8 is a plan view of a portion of an airfoil, according to an embodiment of the present invention.

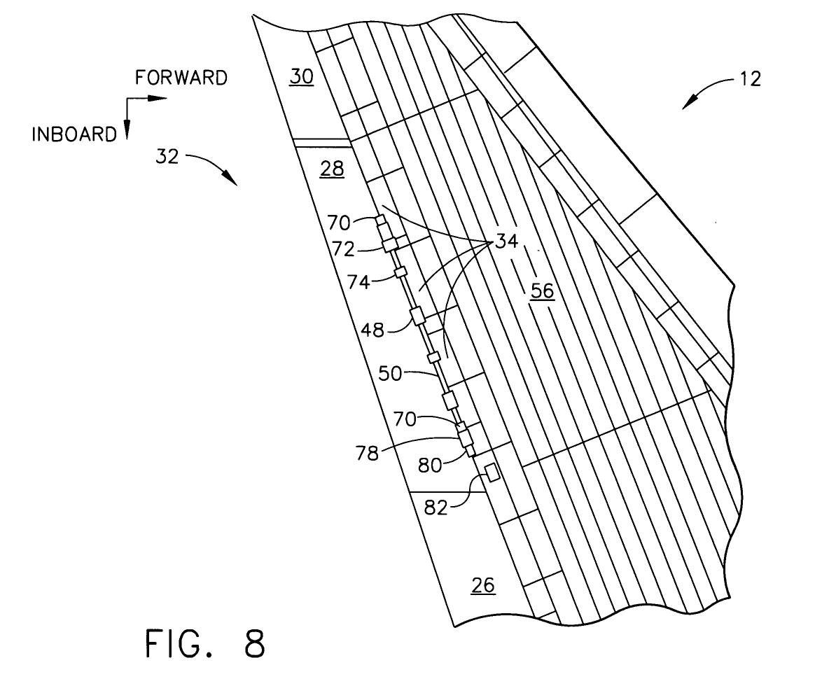

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention is applicable to a variety of aircraft, including those having a thin-wing design, for example, those used for high performance transonic, supersonic flight. Further, various embodiments of the present invention may be retrofitted to a variety of aircraft already in service, such as commercial airliners, thus providing ubiquitous benefits without the cost of having to redesign and produce new models. It is contemplated that the present invention will prove useful, inter alia, for improving flight control during various maneuvers performed at various angles of attack and at various speeds; for example, at transonic and low supersonic speeds.

The present invention provides such improvements with the use of lifters. Use of the lifters may generate the lift with a relatively small yawing moment, as necessary to provide improved levels of control during roll maneuvers. In contrast, deployment of devices known in the prior art, such as outboard ailerons, produce unacceptable adverse flight effects, including effectiveness reversal, such that if a pilot wants to turn the airplane to the left, the airplane would turn to the right at transonic mach numbers and high dynamic pressure. When a swept wing bends upward it twists so that a local angle of attack at the tip is reduced and the total lift on that side is reduced rather than increased, so airplane turns to the wrong side. The reversal speed is highly unpredictable, thus tweaking a flight control computer in such a way that it commands ailerons to go opposite at transonic mach numbers to get desired roll has yet to be accomplished. Further, use of outboard ailerons in a reversed sense induces an undesirable wave mode through the wing, thus leading to practices to “lock out” the outboard aileron at high mach numbers, as conventional airplanes may achieve sufficient roll control from inboard ailerons. However, that is not the case with thin-wing, supersonic design airplanes as they exhibit high levels of aeroelasticity that significantly reduce inboard aileron effectiveness such that they can not satisfy common roll control standards. Further, use of the lifters does not generate undesirable vertical tail loads, as with use of the inboard ailerons. Lifters typically suffer far less aeroelastic loss than their aileron counterparts, thus providing greater effective functionality. Additionally, the size of actuators used to deploy the lifters is comparatively smaller than that of the actuators used with ailerons, which may require high profile devices such as actuator fairings. This feature of the present invention results in minimized drag or hinge moments, thus improving overall performance, for example, providing much higher roll per configuration drag ratio, generally considered very important on a commercial platform.

Further, coordinated use of the lifters and other control devices may provide significant flight advantages, including advance roll control and speed braking capabilities. For example, asymmetric use of the control devices by downward deployment of the lifters and ailerons on one wing and upward deployment of the ailerons and spoilers on the other wing may provide maximum roll, which may be just enough to meet minimum requirements. Without use of the lifters, however, the control devices of the prior art are greatly deficient in providing even the minimal roll control required. Further, they are prone to adverse effects, somewhat negating benefits derived from use of such devices. For example, and as seen in the prior art, use of ailerons without concurrent use of the lifters subject the aircraft to all the aforementioned issues, including untoward drag and ineffective lift during attempted roll maneuvers. Use of the spoilers results in aeroelastic loss, downgrading effective roll maneuvers. Use of inboard spoilers decreases the effectiveness derived from use of inboard ailerons and inboard spoilers use would also be very unfavorable because such use would buffet the horizontal tail in the case of a mid wing configuration. For example, use of middle spoilers on the left wing with inboard ailerons, left wing down and right wing up, provides insufficient roll control. Use of outboard spoilers or ailerons is largely ineffective, due to aeroelastic loss and reversal, particularly in thin-winged aircraft.

Still further, the combined use of lifters and spoilers provide the drag necessary to successfully perform speeding braking maneuvers. In contrast, use of mid spoilers alone significantly decreases the amount of drag sought for emergency descent maneuvers and their use often results in undesirable pitching moments. For this reason, additional spoilers would have to be mounted on the inboard wing to serve as speed breaks only, as they would not be used as roll devices for previously mentioned reasons, so more weight, complexity, and cost would be added to the aircraft.

Another benefit of use of lifters is their ability to serve as maneuver load alleviation devices. If lifters are used in the inboard region of the wing, for example, next to the fuselage, they will produce lift inboard and so move the center of pressure further inboard. In addition, inboard lifters produce nose up pitching moment so the tail will have to produce less negative lift to achieve, for example, a 2.5 g maneuver which will require wing to lift less than if lifters are not used to achieve 2.5 g maneuver. These two combined effects reduce undesirable bending moments. Lifters, therefore, can be implemented or retrofitted on new or existing airplanes to provide a free increase of maximum takeoff weight because the wing becomes able to carry more load, resulting in more range or more payload.

The use of lifters may also alleviate some of the load exerted on the aircraft during certain maneuvers. Lifters—for example, as a bank of small surfaces, but especially the most inboard individual panels—load the inboard wing; spoilers unload the inboard wing (especially the inboard individual panels). In the case of spoilers, this means that the outboard wing has to carry more load to sustain certain maneuvers, thus resulting in adverse bending moments and undesirable heavier structures necessary to sustain such loads. For example, lifters may alleviate loads during 2.5 g maneuvers (maneuvers resulting in a force exerted on the aircraft equal to 2.5 times the weight of the aircraft). Such maneuvers are almost always used to determine optimum wing size and weight. A combination of, for example, inboard lifters inside the mid bank of lifters to produce inboard lift, and outboard spoilers inside the mid bank of spoilers to destroy outboard lift may provide great load alleviation scheme. This load scheme would carry larger proportion of the 2.5 times the weight with the inboard wing resulting in up to, for example, 30% percent lower bending moment which could reduce the weight of the wing by up to 30% percent.

Finally, use of the lifters would counter pitching moments generated by use of the spoilers. Thus, a skilled artisan will recognize that the implementation and use of lifters may improve flight performance, control, and maneuverability, and may reduce structural and operational costs.

The present invention is particularly applicable to sonic cruisers as well as other fast, thin-winged aircrafts and may be useful for maneuvering at transonic or low supersonic speeds. During roll maneuvers, lifters can be employed to effectively almost double the aircraft's roll capabilities, thus improving roll control. The lifters may further increase drag for successful speed braking operations, particularly if deployed in conjunction with spoilers.

Of note, in various embodiments of the present invention, lifters may utilize a greater percentage of heretofore-unused area of the wing to produce increased roll control. For example, prior art uses a “spoilers up and aileron up on one side, and aileron down on the other side”, or use of three wing surfaces. Various embodiments of the present invention permit use of a fourth wing surface when use of the lifters are added to the wing using the downward aileron, in effect increasing use of available “real estate” on the wings by 25%. A lifter of the present invention may be configured as a panel mechanically associated with a lower surface of the wing and positioned at various locations relative to an area generally located near the wingtip (outboard region), an area generally located near the fuselage area (inboard region) or an area therebetween (middle region). The lifters may be positioned spanwise and aft of the ailerons, nearer the trailing edge of the wing than the leading edge of the wing. For example, in certain configurations, they are hinged to the rear spar, rear of the wing box structure.

In various embodiments, the lifters' positions may mirror those of the spoilers; i.e., the lifters are correspondingly positioned relative to the wingtip and the fuselage. While the spoilers attach to an upper surface of the wing, the lifters are attached to a corresponding position on the lower surface of the wing. Further, various means and configurations of the same may be used to attach the lifters to the aircraft structure and to actuate the lifters; for example, hinges. The attachment means and actuation means may be integral or independent of one another. It is contemplated that the lifters may comprise a variety of materials or composite materials.

Referring now to the drawings, wherein similar reference characters designate corresponding parts throughout the drawings, there is shown generally at 10 a portion of an aircraft having a wing 12, a portion of a fuselage 14, and an engine 16. The wing 12 has a wingtip 18, an inboard region 20, a middle region 22, and an outboard region 24. A first aileron 26, a second aileron 28, and a third aileron 30, all deployably attached to the wing 12, form a trailing edge 32 of the wing 12. Spoilers 34, or rectangular panels deployably attached to an upper surface 36 of the wing 12, adjoin the second aileron 28. Lifters (not shown) are configured on a lower surface (not shown) of the wing, at the same position as the spoilers 34, relative to the wing tip 18 and the fuselage 14 (mirror image). In various embodiments, the lifters (not shown) may be configured or retrofitted on the inboard region 20, the middle region 22, the outboard region 24, or a combination thereof.

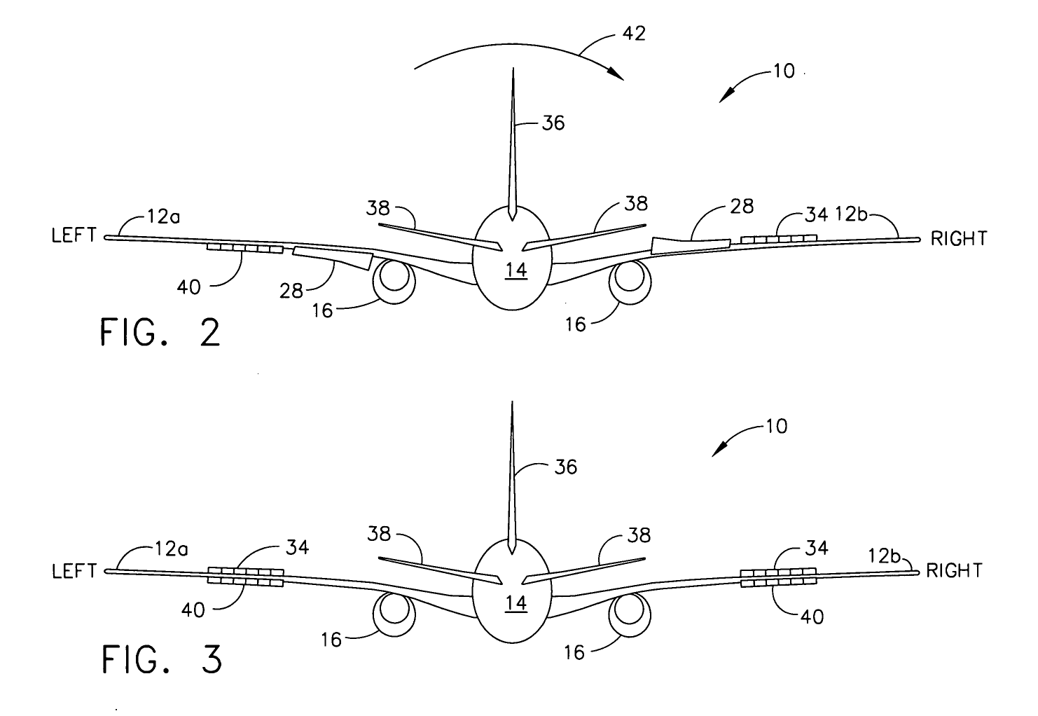

With reference to FIGS. 2 and 3, there are shown a diagrammatic rear view of the aircraft 10 having a fuselage 14, a vertical stabilizer or vertical tail 36, horizontal stabilizers 38, a left wing 12a and a right wing 12b, engines 16, the second ailerons 28, spoilers 34, and lifters 40. FIG. 2 shows the operative positions of the second ailerons 28, the spoilers 34, and the lifters 40 when the aircraft 10 is in flight and initiating a roll maneuver (a three-dimensional move where an aircraft in flight rotates about its longitudinal axis), as depicted by a roll vector shown at 42.

To create the lift necessary for the left wing 12a to roll the aircraft 10 rightward, the second aileron 28 and lifters 40 on the left wing 12a may be downwardly deployed, changing the airflow about the left wing 12a and generating lift. It is noted that the change in airflow generated by the downward deployment of the lifters 40 do not result in significant and undesirable loads on the vertical stabilizer 36, thus providing significant lift without correspondent adverse effect.

To create the drag necessary to maintain control during the roll, the second aileron 28 and the spoilers 34 are upwardly deployed from the right wing 12b, imparting the desired yaw moment to the aircraft 10 and relieving the requirement for oversized rudders and other resultant costly configurations.

FIG. 3 shows the operative positions of the spoilers 34 and lifters 40 of both wings 12a, 12b, when the aircraft is in flight and initiating a speed braking maneuver to slow the airspeed of the aircraft. To initiate such a maneuver, the spoilers 34 may be upwardly deflected and the lifters 40 may be downwardly deflected on both wings 12a, 12b to impart a drag force on both wings 12a, 12b, thus slowing the aircraft.

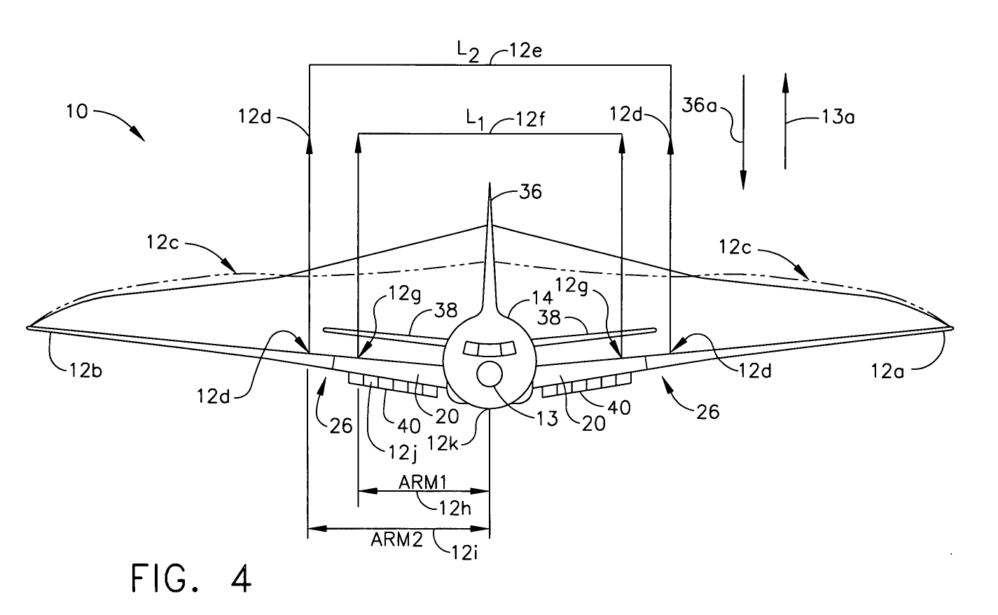

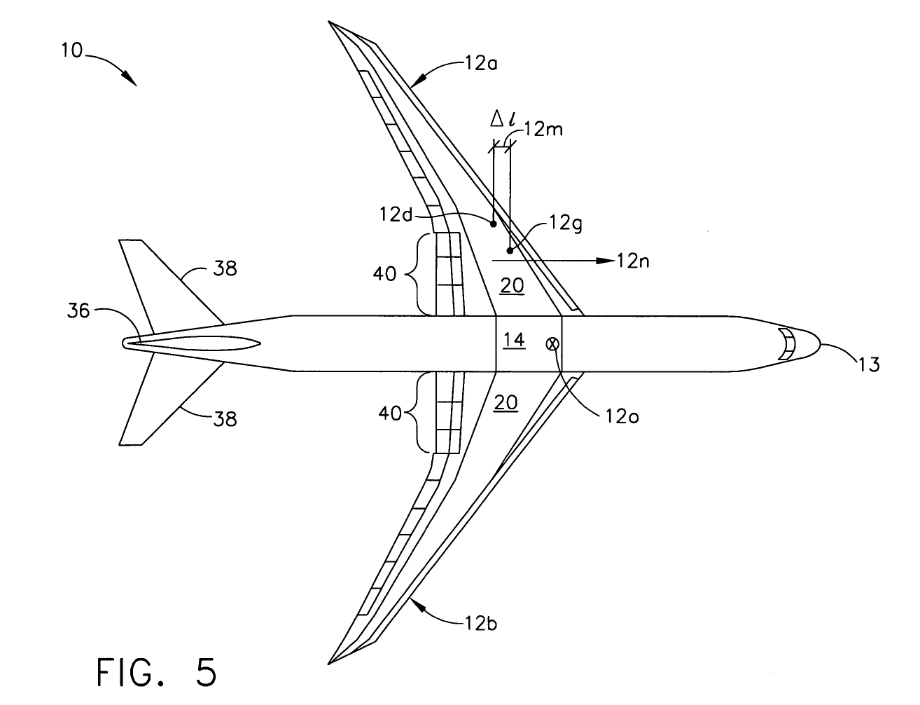

To provide maneuver load alleviation, various embodiments of the present invention may utilize lifters as depicted, for example, in FIGS. 4 and 5. For example, as shown in FIG. 4, the aircraft 10 having lifters 40 on the inboard region 20 of the wing 12 and on a lower surface generally corresponding to that shown at 26. When the lifters are deployed at 40, they may produce lift in the inboard region 20, relieving an undesirable bending moment. This concept may be illustrated as follows. For example, if an airplane structure—with or without lifters—is sized to achieve 2.5 g's and weighs one million pounds, then 2.5 million pounds of lift must be generated to achieve the 2.5 g maneuver. In aircraft of the prior art (without lifters), to achieve a 2.5 g maneuver, the pilot must command the aircraft in a nose-up position (wherein the nose 13 of the aircraft is angled up relative to the aircraft's longitudinal line of direction or a nose-up pitching moment as shown at 13a), forcing the airplane wings to a higher angle of attack to have the wings generate the additional lift. To pitch the aircraft up, the tail must push down as shown at 36a, thus producing approximately—300,000 pounds of lift. In view of the negative tail lift, the wing 12 and fuselage 14 would have to produce approximately 2.8 million pounds to achieve the net 2.5 million pounds of lift necessary to sustain the 2.5 g maneuver. In addition, during such a maneuver without the benefit of lifters, the span load 12c (or lift distribution) on the wing creates a certain undesirable bending moment. The bending moment is defined as:
M=L*ARM,
where L represents the summation of all lift vectors acting at one averaged point or center of aerodynamic pressure, or the center of lift and ARM represents the distance from the center of pressure to the center line of the airplane. In this particular example, and with reference to FIG. 4, the bending moment generated by an aircraft without use of the lifters may be expressed as M₂=L₂*ARM₂, where the bending moment, M₂ equals the product of the center of aerodynamic pressure located at 12d on wing 12a or 12b, and the distance from the center 12k of the aircraft 10 to the center of pressure 12d, shown as ARM₂ at 12i.

In contrast, to decrease the undesirable bending moment, the lifters 40 may be deployed. Continuing with the foregoing scenario, when the lifters 40 are deployed, the lifters 40 can produce the additional lift on the inboard region 20 of the wing 12a or 12b. The eliminates the need for the aircraft 10 to achieve a high angle of attack required without the use of lifters 40, yet produces the same amount of lift (for example, 2.5 million pounds). This concept is illustrated in FIG. 4, where the center of aerodynamic pressure is shown at 12g on wings 12a, 12b and the distance from the center 12k of the aircraft 10 to the center of pressure 12g, shown as ARM₁ at 12h. As compared with the center of pressure 12d, it can be seen that the center of pressure 12g has been moved to the inboard region 20 of the wing 12a, 12b, and closer to the fuselage 14. In doing so, the total distance represented by ARM₁ (12h) has been reduced in comparison to ARM₂ (12i). The bending moment calculated for the maneuver using the lifters, then, can be expressed as M₁=L₁*ARM₁. A comparison of the bending moments M₁ and M₂ reveal that the bending moment M₁ has been reduced because ARM₁ is less than ARM₂, providing that the lift remains the same; i.e., L₁=L₂.

Another advantage of using the lifters 40 configured in the inboard region 20 of the wings 12a, 12b is the comparatively light design configurations of aircraft as compared with aircraft of the prior art, wherein the light design results in improved airplane performance. For example, continuing with the foregoing scenario and with reference now to FIG. 5, there is shown an aircraft 10 having wings 12a, 12b configured with lifters 40. When the aerodynamic center of pressure is moved inboard, as previously explained, it is also moved forward (i.e. in a direction towards the direction of flight, as shown at 12n), resulting, for example in a difference in distance of Δl shown at 12m. This movement forward makes the pitching moment ARM shorter and closer to the airplane's center of gravity 12o. If the airplane was balanced prior to the MLA deployment of lifters, after the deployment it will pitch up without any input from the tail 36, 38. Thus, the tail 36, 38 will have to produce less negative force to pitch up the airplane to pull the 2.5 g maneuver in the continuing scenario. For example, instead of producing the—300,000 pounds of tail load, with the lifters 40 deployed, it will take only—250,000 pounds, and thus the wings 12a, 12b will have to produce less lift. Therefore, with use of the lifters 40, the bending moment is relatively smaller than the bending moment generated without use of the lifters. Specifically, L₁ is less than L₂ and ARM₁ is less than ARM₂, therefore the product M₁ is smaller than M₂. In this example, without lifters, the wing has to produce 2.8 million pounds (offsetting the 0.3 million pounds of negative tail lift) to reach the 2.5 million pounds of lift necessary to successfully accomplish the 2.5 g maneuver. With use of the lifters 40, however, the wing has to produce only 2.75 million pounds and the tail produces only 0.25 million pounds of negative lift. Because the lift requirement is lessened with the use of lifters, a skilled artisan will note that wings and tails structures may be sized to lower loads, thus providing lighter structures and more efficient performance.

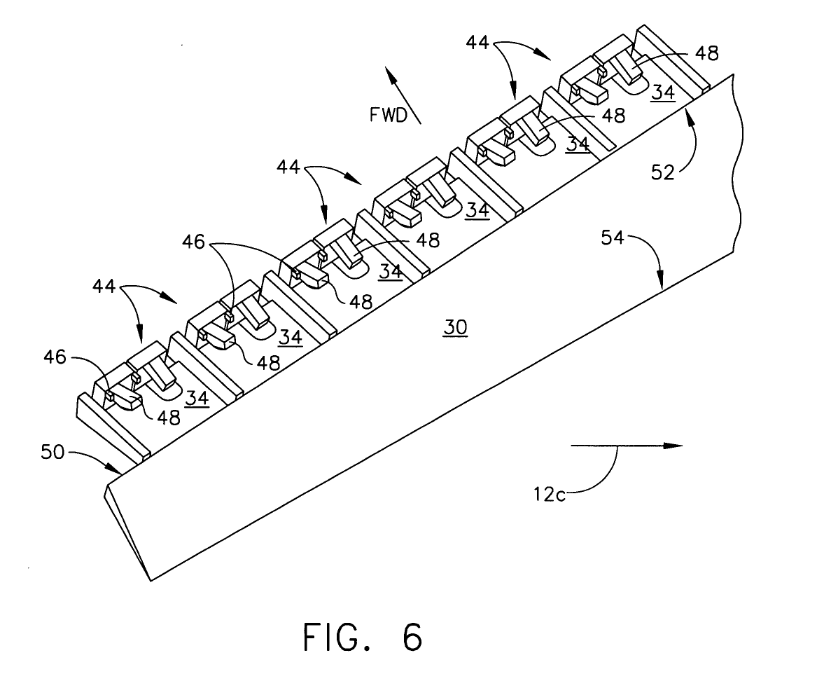

FIG. 6 shows a space view of a portion of the wing 12 oriented according to the inboard direction 12c, the portion of the wing 12 having an aileron 28, spoilers 34, attachment means shown generally at 44 for attaching the spoilers 34, the lifters (not shown, configured as mirror images to the spoilers), or both, to a surface of the wing. In various embodiments, a connective (and actuating) member such as a torque tube 50 may function as a connective element for various components mechanically associated with the ailerons, spoilers, and lifters. For example, the aileron may pivotally connect to the torque tube along a first edge 52. A second edge 54 of the aileron 28 may form a portion of the trailing edge of the wing.

In various embodiments, the attachment means may comprise pivotal means shown generally at 44 having, for example, hinge mechanisms 46 and actuators 48. With continued reference to FIG. 4 and now with reference to FIG. 5, there is shown in cross-section an embodiment of the present invention having pivotal means 44, the spoiler 34, the lifter 40, and the third aileron 30. The spoiler 34 and the lifter 40 may be attached to an upper surface 56 and a lower surface 58, respectively, of the wing 12 via the respective hinge mechanism 46. The hinge mechanism 46 may be operatively connected to the actuator 48 having a connective end 60 attaching the spoiler 34 or the lifter 40. The spoilers 34 and lifters 40 may taper to an edge 60 adjacent to the torque tube and spatially proximate to the aileron 30. Operatively, and cooperatively with various combinations of components (not shown), in various embodiments of the present invention, the spoiler 34 and the lifter 40 may be deployed or deflected when the actuator 48 actuates a respective spoiler 34 or lifter 40 pivotally about a hinge mechanism 46. For example, the spoiler 34 and the lifter 40 may be selectively deployed to various degrees relative to the upper surface 56 and lower surface 58 of the wing 12, up to a full deployment of 60 degrees, as shown at a first position 64 and a second position 66, respectively. The aileron may be selectively deployed, for example, to an angle of 20 degrees shown in phantom at a third position 68.

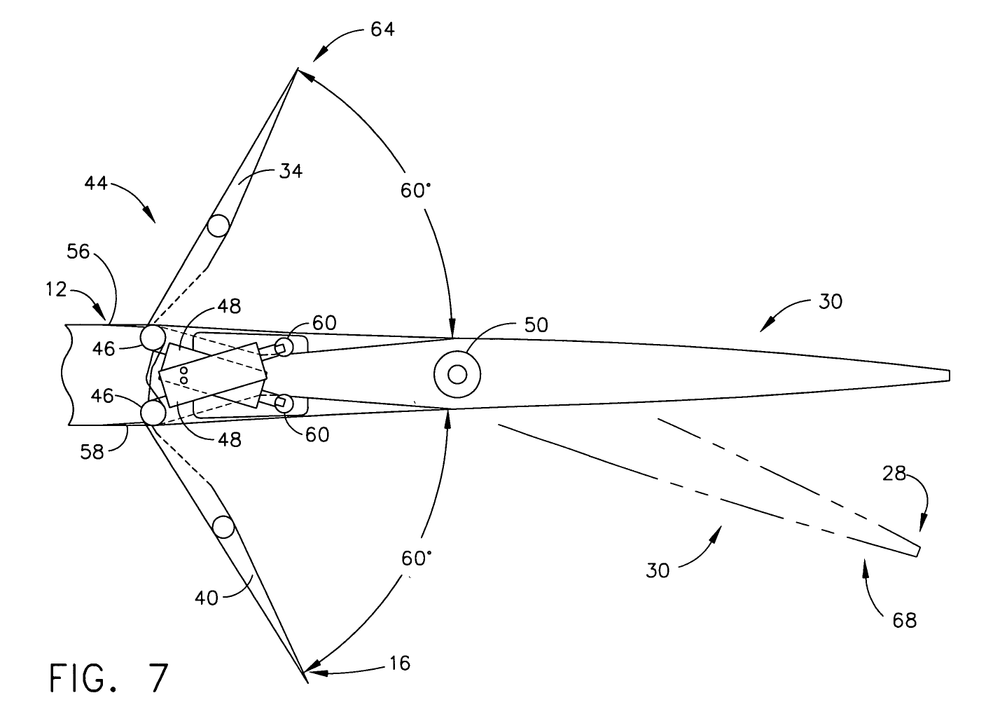

With reference to FIG. 7, there is shown an exemplary embodiment of the present invention showing the aforementioned components relative to various components used to effect various functions respective to flight control devices of the wing 12. For example, the wing 12 having the first aileron 26, the second aileron 28, the third aileron 30, and torque tube 50 further comprises a position sensor 70 for sensing the relative position of various flight control devices; a wing tip brake 72; a torque tube support 74; a gearbox 78 for translating motion to various components; a hydraulic motor 80 for generating motion; and a control valve 82 for effecting flow control. A skilled artisan will note that the aforementioned components of the present invention readily coexist and provide cooperative functionality along the trailing edge of the wing 12 without adversely effecting size, weight, and cost advantages.

It should be understood, of course, that the foregoing relates to preferred embodiments of the invention and that modifications may be made without departing from the spirit and scope of the invention as set forth in the following claims.

1. A flight control system for an aircraft wing having an upper surface, a lower surface, an inboard region, a middle region, and an outboard region, the aircraft wing used with an aircraft, the flight control system comprising:
at least one lifter deployably attached to a lower wing surface.

2. The flight control system of claim 1, wherein the at least one lifter is deployably attached to at least one area selected from a group consisting essentially of the inboard region, the middle region of the wing, and the outboard region of the wing.

3. The flight control system of claim 1, wherein the at least one lifter further comprises a plurality of lifters.

4. The flight control system of claim 1, further comprising at least one spoiler deployably attached to the upper surface of the wing.

5. The flight control system of claim 4, wherein the at least one lifter and the at least one spoiler are configured in corresponding regions on the wing, the at least one lifter configured respective to the lower surface of the wing and the corresponding at least one spoiler configured on the upper surface of the wing.

6. The flight control system of claim 5, wherein the at least one lifter and the at least one spoiler are symmetrically deployable to the same degree.

7. The flight control system of claim 5, wherein the deflection is approximately 60 degrees.

8. A flight control system for winged aircraft, the flight control system comprising:
wings having:
an upper surface;
a lower surface;
an inboard region;
a middle region; and
an outboard region; and
a plurality of lifters, each lifter in the plurality of lifters deployably attached to the lower surface of the wing.

9. The flight control system of claim 8, further comprising a plurality of spoilers, each spoiler in the plurality of spoilers deployably attached to the upper surface of the wing.

10. The flight control system of claim 9, wherein each lifter in the plurality of lifters is configured in a position that corresponds to that of a respective spoiler in the plurality of spoilers.

11. The flight control system of claim 8, wherein each lifter in the plurality of lifters is located in a region selected from a group consisting essentially of the inboard region, the middle region, and the outboard region of the wing.

12. The flight control system of claim 8, further comprising attachment means.

13. The flight control system of claim 8, wherein the attachment means further comprises pivotal means.

14. The flight control system of claim 13, where the pivotal means further comprises a hinge mechanism.

15. The flight control system of claim 13, wherein the pivotal means further comprises an actuator.

16. A flight control system for aircraft, the flight control system comprising:
a pair of wings, each wing in the pair of wings having:
a lower surface;
an upper surface;
an inboard region;
a middle region; and
an outboard region;
a plurality of lifters, each lifter in the plurality of lifters attached to the inboard region, the middle region, the outboard region, or a combination thereof, of the lower surface of each wing in the pair of wings;
a plurality of a hinge mechanisms for pivotally attaching each lifter in the plurality of lifters to a respective wing in the pair of wings; and
a plurality of actuators, each actuator in the plurality of actuators in operative engagement with a respective hinge mechanism in the plurality of hinge mechanisms, each actuator in the plurality of actuators for selectively actuating the hinge mechanism, causing an angular deployment or return of a respective lifter in the plurality of lifters from its initial position relative to the lower surface of one wing in the pair of wings.

17. A flight control system for controlling a roll maneuver of an aircraft having a pair of wings, ailerons, spoilers and lifters, the flight control system comprising:
means for selectively downwardly deploying the ailerons and selectively deploying the lifters on one wing in the pair of wings to generate lift; and
means for selectively upwardly deploying the ailerons and selectively deploying the spoilers on the other wing in the pair of wings to destroy lift.

18. The flight control system of claim 17, wherein the spoilers and lifters are configured as mirror images.

19. The flight control system of claim 17, wherein the lifters are similarly configured on each wing in the pair of wings.

20. A flight control system for speed braking an aircraft having a pair of wings, each wing in the pair of wings configured with ailerons, spoilers and lifters, the flight control system comprising:
means for selectively downwardly deploying the ailerons and selectively deploying the lifters on one wing in the pair of wings to generate lift; and
means for selectively upwardly deploying the ailerons and selectively deploying the spoilers on the other wing in the pair of wings to produce drag.

21. The flight control system of claim 20, wherein the ailerons, spoilers, and lifters are positioned in at least one region selected from a group consisting essentially of an outboard region of each wing in the pair of wings and a middle region of each wing in the pair of wings.

22. A flight control system for a thin, long wing of an aircraft, the wing having a lower surface and an upper surface, the flight control system comprising:
a plurality of lifters, each lifter in the plurality of lifters attached to the lower surface of each wing.

23. The flight control system of claim 22, further comprising a plurality of attachment means, each attachment means in the plurality of attachment means for attaching a respective lifter in the plurality of lifters to the lower surface of the wing.

24. The flight control system of claim 23, wherein each attachment means in the plurality of attachment means further comprises a hinge mechanism for pivotal attachment of the respective lifter in the plurality of lifters to the lower surface of the wing.

25. The flight control system of claim 23, wherein each attachment means in the plurality of attachment means further comprises an actuator for angular deflection of a respective lifter in the plurality of lifters.

26. The flight control system of claim 22, further comprising a plurality of spoilers attached to the upper surface of the wing.

27. The flight control system of claim 26, wherein each spoiler in the plurality of spoilers is configured as a mirror image of a respective lifter in the plurality of lifters.

28. A method for speed braking an aircraft with a pair of wings, each wing in the pair of wings having a plurality of lifters and a plurality of spoilers, the method comprising steps of:
selectively deploying at least a portion of the plurality of lifters and at least portion of a plurality of spoilers during flight to cause drag on the aircraft, reducing its speed, its altitude, or both.

29. The method of claim 28, further comprising an initial step of configuring the at least a portion of the spoilers in the plurality of spoilers and the at least a portion of lifters in the plurality of lifters as mirror images.

30. The method of claim 28, further comprising an initial step of similarly configuring the plurality of lifters on each wing in the pair of wings.

31. A method of controlling a roll maneuver of an aircraft having a pair of wings, each wing in the pair of wings configured with ailerons, spoilers and lifters, the method comprising steps of:
selectively downwardly deploying the ailerons and lifters on one wing in the pair of wings to generate lift; and
selectively upwardly deploying the spoilers and the lifters on the other wing in the pair of wings to destroy lift.

32. The method of claim 31, further comprising an initial step of configuring the ailerons, spoilers, and lifters in a middle region or outboard region of the wing.

33. The method of claim 31, further comprising an initial step of providing an aft wing—canard configuration.

34. The method of claim 31, further comprising an initial step of providing a mid-wing horizontal tail configuration of the aircraft.

35. The method of claim 31, further comprising an initial step of providing a pair of twin vertical tails mechanically associated with the aircraft

36. The method of claim 31, further comprising providing the wings according to a long, thin design.

37. A method for providing maneuver load alleviation for an aircraft with a pair of wings, each wing in the pair of wings having an inboard region configured with a plurality of lifters, the method comprising a step of: selectively deploying at least a portion of the plurality of lifters.

38. The method of claim 37, further comprising a step of:
selectively deploying at least a portion of the plurality of lifters to produce lift inboard.

39. The method of claim 37, wherein the step further comprises selectively deploying at least a portion of the plurality of lifters to produce a nose-up pitching moment.

40. The method of claim 37, wherein the step further comprises selectively deploying at least a portion of the plurality of lifters to reduce a bending moment.

41. The method of claim 38, wherein the step further comprises selectively deploying at least a portion of the plurality of lifters resulting in a center of force located on the inboard region of at least one wing in the pair of wings.

42. The method of claim 37, further comprising steps of configuring a plurality of spoilers on each wing in the pair of wings and selectively deploying at least a portion of the spoilers.

43. The method of claim 38, further comprising steps of configuring a plurality of spoilers on each wing in the pair of wings and selectively deploying at least a portion of the spoilers.
